(19) United States
(12) Patent Application Publication
(10) Pub. No.: US 2020/0156520 A1
(43) Pub. Date: May 21, 2020

(54) Lucas pro seat

(71) Applicant: Eugene Daniel Lucas, Dunmore, PA (US)

(72) Inventor: Eugene Daniel Lucas, Dunmore, PA (US)

(21) Appl. No.: 15/932,966

(22) Filed: May 31, 2018

(51) Int. Cl. B60N 2/64; A63B 55/60

(52) U.S. Cl. CPC B60N 2/646; A63B 2055/601; A63B 55/60

(57) ABSTRACT

The Lucas Pro Seat protects the prostate area of the male rider from continuous bouncing and jarring by providing an air space between the seat and the prostate. The Lucas Pro Seat is a stationary seat. The stationary seat would have two 9.5″ square seats with a 2″ air space.

The 42″ stationary seat would have two 9.5″ square stationary seats at each end with a 2″ air space. The center of the seat would be 9″ by 21″ and would be stationary. The center space of each cushion would have a depth of 2″.

### RELATED APPLICATIONS

U.S. Pat. No. 8,113,583 B2 granted on Feb. 14, 2012

U.S. Pat. No. 9,039,084 B2 granted on May 26, 2015

### FIELD OF INVENTION

The Lucas Pro Seat allows for the prostate to ride over a 2″ cushion of air rather than resting directly on the seat. The seat is covered by 1/16 inch thin vinyl whereby each 2″ air space is hidden beneath the vinyl. Prior patents have dealt with adjustments of the seat length, seat width, arm dividers, seat back adjustments and the entire seat tilt adjustment. The Lucas Pro Seat has 2″ depth seat cushions which are 9.5″ square. As men age their prostate begins to enlarge. The larger the prostate is the more impact it will have on the conventional golf cart seat.

The present invention is designed to eliminate the impact of the prostate on the golf cart seat and provides comfort.

### BACKGROUND OF THE INVENTION

Golf carts without prostate protection are commonly used on all golf courses today. Continuous bumping and jarring of the prostate area during the ride over time may cause the prostate to enlarge.

### SUMMARY OF THE INVENTION

The present invention eliminates the impact on the prostate by providing a 2″ air space between the seat and the prostate. This is achieved by the use of 9.5″ square seats with a 2″ in depth air space for each rider.

### BRIEF DESCRIPTION OF THE DRAWINGS

The proceeding aspects and the prostate protection of this invention will become more readily appreciated as the same become better understood by reference to the enclosed detailed description in conjunction with the accompanying drawings and FIGURES, wherein:

FIG. 1 is the Lucas Pro Seat top view showing the 42″ seat which has 2 (two) 9.5″ seat cushions with a 2″ depth air pocket within each cushion covered by vinyl;

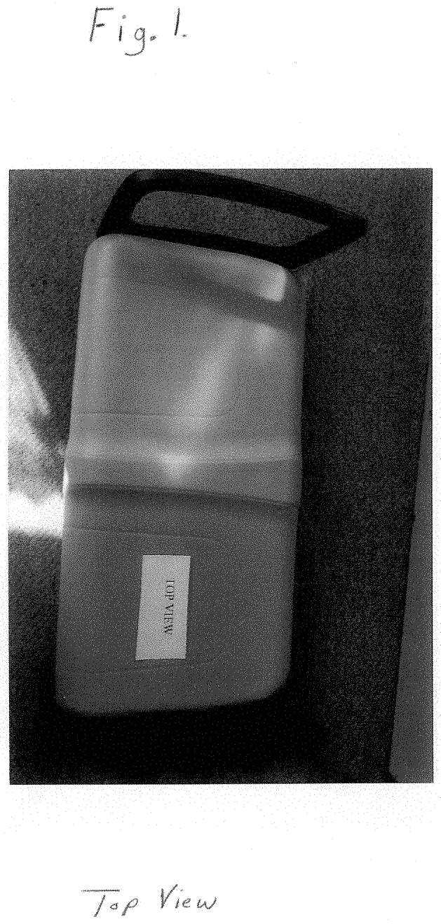

FIG. 2 is the Lucas Pro Seat left side view

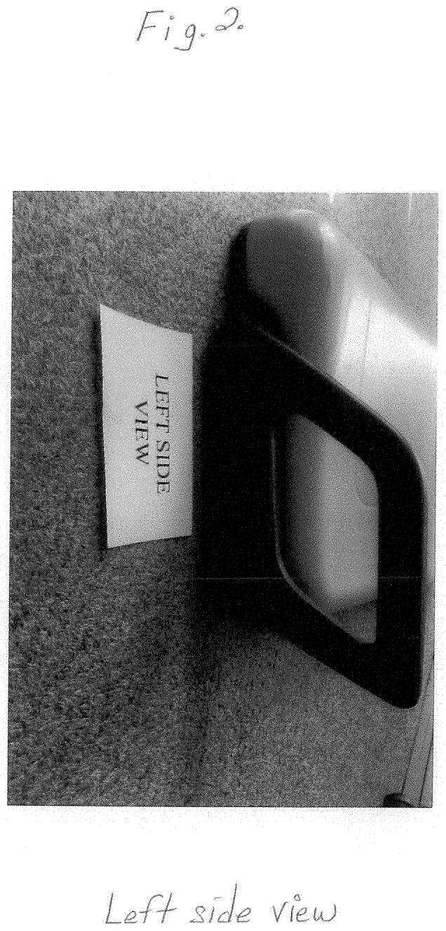

FIG. 3 is the Lucas Pro Seat right side view

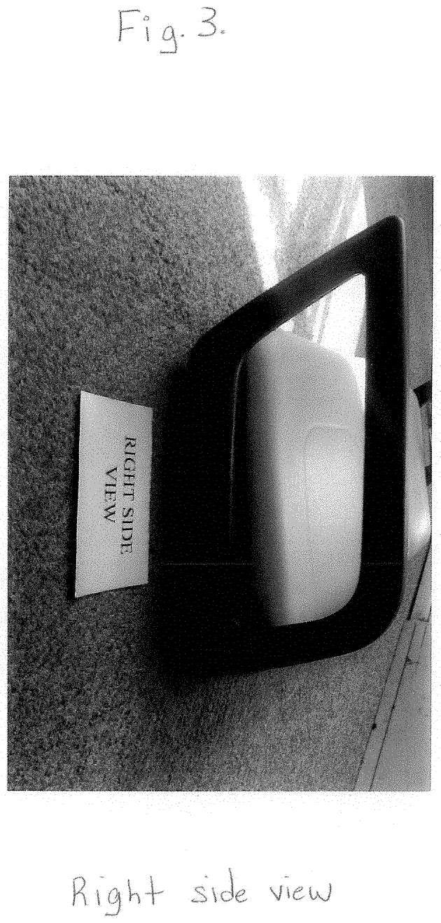

FIG. 4 is the Lucas Pro Seat front view;

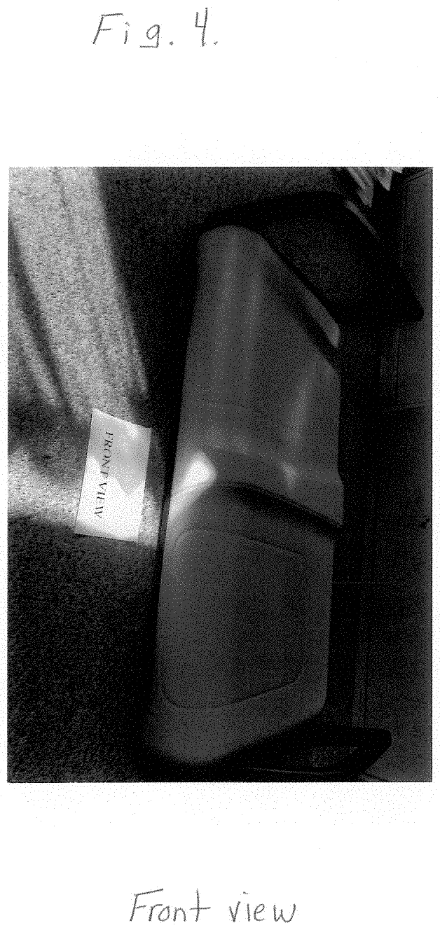

FIG. 5 is the Lucas Pro Seat rear view;

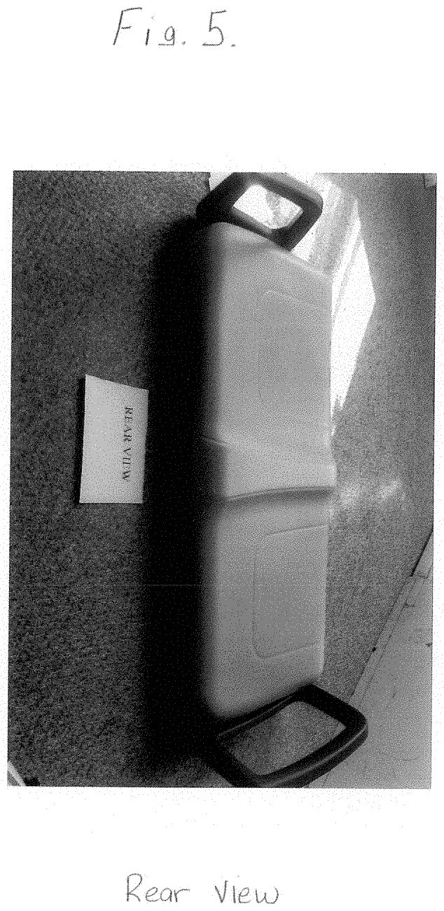

FIG. 6 is the Lucas Pro Seat is the bottom view. This is the seat version that incorporates a ⅝th inch plywood and 2″ nylon bands for seat support;

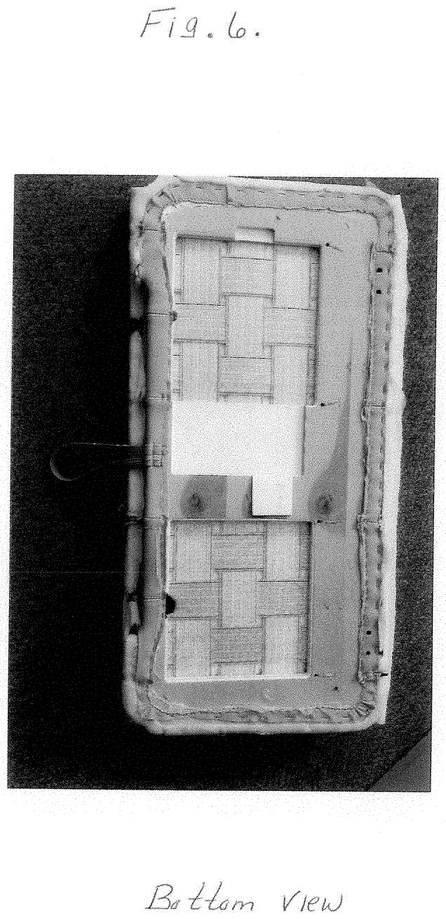

FIG. 7 is the Lucas Pro Seat top view without vinyl;

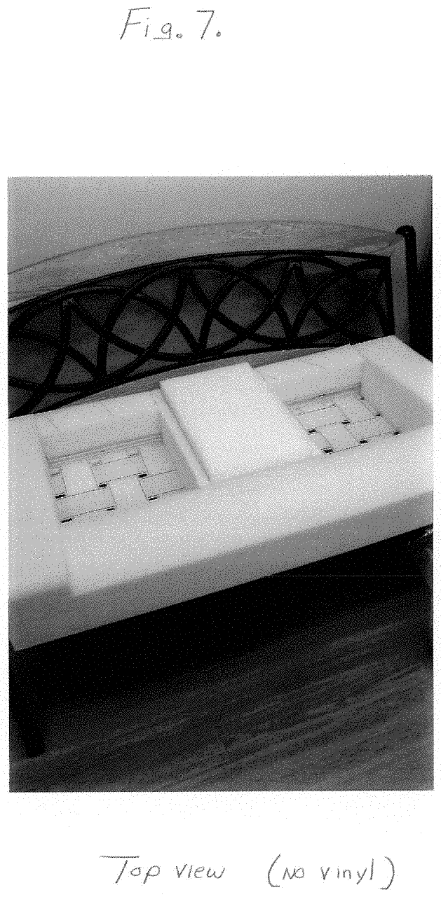

FIG. 8 is the Lucas Pro Seat front view without vinyl;

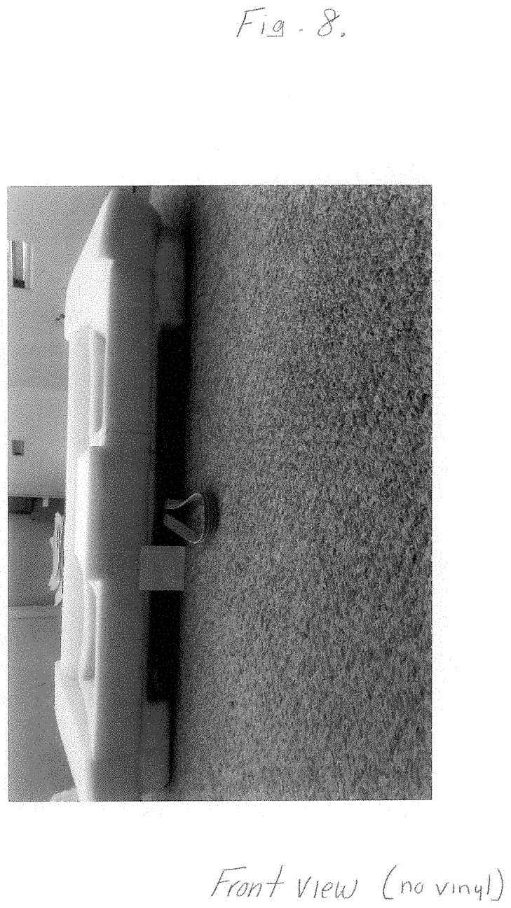

### DETAILED DESCRIPTION OF LUCAS PRO SEAT

The Lucas Pro Seat is a 42″ golf cart seat which consists of two two 9.5″ square stationary seats. Each seat would have a 2″ air space.

Conventional golf cart seats exert the rider's weight throughout the prostate area. During the ride over the golf course, a great deal of bumping occurs over the prostate area.

The Lucas Pro Seat is designed to eliminate that impact and provide comfort. The Lucas Pro Seat consists of two 9.5″ square seats which would be stationary. The depth of each seat cushion would be 2″ with a 5″ cushion on each side.

The Lucas Pro Seat would be made of foam or a similar product.

What is claimed is:

1. a golf cart seat comprising:
two 9.5″ square stationary seats for each rider;
whereby each seat has an air space of 2″;
wherein the rider would sit on a cushion of air under the vinyl seat cover
the space between each 9.5″ square seat cushion would be 2 inches below the riders prostate thereby eliminating the bumping that occurs during the ride.

2. a golf cart seat comprising:
two 9.5″ by 9.5″ seats within a 42″ by 21″ seat;
two 2″ depth air pocket within each seat cushion;
wherein the 9″ center which is stationary
